(19) United States
(12) Patent Application Publication
(10) Pub. No.: US 2008/0005883 A1
(43) Pub. Date: Jan. 10, 2008

(54) Assembling equipment and assembling method to affix a profiled structure to a window pane

(76) Inventor: Wolfgang Platt, Biedenkopf-Kombach (DE)

Correspondence Address: CLARK & BRODY, 1090 VERMONT AVENUE, NW, SUITE 250, WASHINGTON, DC, 20005, US

(21) Appl. No.: 11/822,556

(22) Filed: Jul. 6, 2007

(30) Foreign Application Priority Data
Jul. 7, 2006 (DE) 10 2006 031 821.8

(51) Int. Cl. B23P 11/02

(52) U.S. Cl. 29/446; 29/235; 29/281.4; 29/701

(57) ABSTRACT

The object of the present application relates to assembling equipment (1) and an assembling method to affix a profiled structure (11) to a pane, in particular to a motor vehicle windshield, said equipment comprising a pane feed device (3) to guide a pane into a first, predetermined assembly position, further a profiled structure's feed device (4) to guide a profiled structure (11) into a second assembly position near the first, also joining means in order to assembly the profiled structure (11) and the pane at a common assembly position, said joining means including elastic, expansive compressive means (12) which, when activated, shall expand their volume in a manner to join the pane and the profiled structure (11).

The present invention relates to assembling equipment defined in claim 1. It further concerns an assembly bench defined in claim 17. Moreover it relates to an assembling method defined in claim 18, to a computer program defined in claim 23 and to a computer program product defined in claim 24. Not least it relates to the application of assembling equipment defined in claim 20.

Equipment is widely known in the state of the art with which a rubber/elastomer “profiled structure”—herein connoting an elongated structure of constant and defined cross-section (profile) such as U channels or T bars and the like—is assembled to the edge zone of illustratively an automotive windshield/pane in assembling equipment, said elastomer/rubber profiled structure being positioned by means of several rollers which reciprocate along the rubber profiled structure and are appropriately positioned at the said profiled structure in order to force it against this windshield.

This procedure incurs drawbacks, namely that on one hand the rubber profiled structure and the windshield already must have been optimally configured relative to each other, and as a result the intrinsically high accuracy demanded in this procedural step entails vast costs in time and labor. On the other hand, because the rubber profiled structure must be affixed adhesively to the windshield within a predetermined and usually short time interval to allow adhesive bonding to the windshield, the proper position must be reached quickly lest the profiled structure be out of alignment.

Accordingly it is the objective of the present invention to create assembling equipment, an assembling bench and a method allowing simplified assembly of profiled structure and windshield and reliable bonding by adhesive.

This problem is solved by the features of claim 1, an assembling bench defined in claim 17 and an assembling method defined in claim 18.

Moreover another objective of the present invention is to create a computer program and a computer program product implementing said method on a computer.

Said objective is solved by a computer program defined in claim 23 and a computer program product defined in claim 24.

The present invention includes the technical insight that in order to assemble a profiled structure to a pane, in particular to a motor vehicle windshield, assembling equipment must comprise a pane feed device guiding a pane into a first predetermined assembly position, further a profiled structure's feed device guiding a profiled structure into a second assembly position near the first one, and joining means, so that the profiled structure and the pane may be joined into a common assembled position, said joining means comprising elastic, expansible compressive means which change volumetrically when being activated in a manner that the pane and the profiled structure shall be assembled.

This volumetric change may be an expansion in volume, a volume deformation and/or another change in volume.

This change in volume offers the advantage that for instance by means of an increase in volume of the compressive means generating a corresponding compression, furthermore any tolerances, in particular those of the assembled partners, further any gaps or the like, that might arise on account of less accurate alignment, may be compensated. As a result coarser and hence more rapid positioning may be carried out while compensating the play generated in the process. In turn higher output is attained while keeping quality at least constant but typically improving it. The same effect may be attained in similar manner using by an expansion or deformation of volume. Such expansion or deformation of volume may take place separately or in combination.

The compressive means are designed to be elastic because of the desirability that following compression, they shall resume their initial state to allow their renewed use in subsequent joining procedures.

A change and preferably an expansion in volume preferably takes place uniformly in all directions of said compressive means. Preferably the compressive means also may be designed in a manner that it shall expand only in a partial zone or direction for instance by being bonded to other materials or being through housings or the like.

The volume change, preferably in the form of volume deformation, also may be designed by making the compressive means anisotropic. Illustratively when the compressive means act in one direction, they shall expand in another.

The activation may be arbitrary, illustratively it may be implemented by thermal energy to raise the temperature of the compressive means which thereby shall expand. On the other hand activation also may be caused by lowering the temperature, for instance using water or materials having memory for which a drop in temperature causes volume expansion. Activation also may be carried out by pressurizing a compressive means with a hydraulic oil or compressed air. A still further activation may be changing the position of the housing parts. Such a change in position may entail deforming the compressing means illustratively being compressed.

In a preferred embodiment mode, the compressive means comprise a first, elastic tube. This tube may be configured especially conveniently along a profiled structure because exhibiting good elasticity when not compressed. The elastic material is arbitrary; preferably however it is an elastomer/rubber.

Preferably as well the compressive means include a second, elastic tube. This design is simpler and more economical. Both tubes may be made of the same material and may exhibit similar or different geometries. Identical design, especially regarding the kind of activation, allow identical pressurization control and reducing spare parts inventory. Moreover equipment mechanism is simplified and the control procedure, in particular the software controlling the equipment is simpler thereby.

Preferably too the profiled structure's feed device shall comprise a seat receiving said profiled structure. The said seat allows receiving in simple manner the profiled structure which preferably is made of plastic. The profiled structure is optimally received in such a seat and can be commensurately well guided.

In a preferred embodiment mode of the present invention, the profiled structure's feed device comprises moreover a displaceable profiled structure receiving slide fitted with said seat. Said slide also allows optimally displacing the profiled structure seat together with the profiled structure it receives. The profiled structure receiving slide may be displaceable in one or more directions.

In a further preferred design, the profiled structure seat is fitted with a track receiving said profiled structure. The design of said track allows easily manufacturing an optimal profiled structure seat. A receiving track also allows seating complex profiled structures. In particular complex plastic profiled structures may be seated by means of a receiving track. Preferably the track is configured in its ideal, nominal position in order to constrain said profiled structure into or nearly into its ideal position.

A further embodiment mode provides that the compressive means are operationally linked with and mounted on the profiled structure's receiving track. Because the compressive means are operationally linked to said track, the compression paths are made short. Preferably the compressive means are part of the profiled structure's receiving track. In this manner, besides applying pressure, the compressive means also support said profiled structure.

In a further preferred design, the compressive means are configured adjacent to and along the contour of the profiled structure receiving track. In this manner a related compressive and preferably tubular means may be constituted over the entire contour which must be received.

In still another preferred design, the first compressive means is operationally and laterally linked to the receiving track for the purpose of transmitting a substantially side-ways compression onto the inserted profiled structure. In this way the said profiled structure may be compressed and be supported in one direction.

As regards optimal compression, preferably the second compressive means is configured underneath the receiving track and is operationally linked to it in order to transmit a compression acting substantially perpendicularly to the connection zone of the profiled structure onto an inserted profiled structure. In this manner the two compressive means apply compression in two different directions and as a result optimal compression is feasible. The two parts—profiled structure and pane—to be connected preferably are joined to each other in one connection zone. This connection zone comprises corresponding contact areas. Accordingly, a first connection zone is subtended at the profiled structure and a second contact area at the pane. The connection zones are each subtended in a corresponding plane and these planes are related to each other. Compression is carried out in part perpendicularly to the connection zone and as a result the required compression may be utilized optimally. Preferably the connection zone is a bonding area.

In a preferred embodiment mode, the compressive means are designed as compressed air tubes activated by compressed air. In this manner compression may be implemented merely by applying compressed air to the tubes. Compressed air is an advantageous and widely available pressurizing medium allowing high compressions. Also compressed air is ecological and may be gently dissipated or reused.

In another embodiment mode of the present invention, the profiled structure's feed device comprises a vertically displaceable (vertical) slide and a horizontally displaceable (horizontal) slide. One of said slides may be designed as the displaceable profiled structure receiving slide. This slide is displaceable vertically and horizontally in two different directions, preferably in mutually orthogonal directions. Herein “horizontal” and “vertical” are terms preferably relating to the pane's feed direction, this pane preferably being guided horizontally.

In another embodiment mode, the vertically displaceable slide and the horizontally displaceable slide are guided in mutually linked manner by means of a movable cam plate. In this process the displacement of one slide depends on that of the other, as a result of which one guided slide displacement is controlled by the other slide. Preferably this design shall be implemented using a movable cam plate.

Accordingly the movable cam plate preferably shall be fitted with an aperture within which one of the two slides is guided in constrained manner. The slide being guided in the aperture is appropriately fitted with an extension entering said aperture and guided along the recess. Preferably two movable cam plates and two portions are used to assure good guidance. Preferably the extensions are configured in a manner that they shall run along the aperture rim during a guided displacement.

One illustrative embodiment mode of the present invention provides that the movable cam plate be firmly affixed to the other of the two slides. This design implements in simple manner a linked and controlled guidance of the two slides. If now one of the slides is displaced, the slide-mounted movable cam plate shall be displaced jointly with that slide. The other slide, which is guided within the aperture of the movable cam plate, is able to move on its own only as allowed by the shape of the said recess. By being guided along the rim of the movable cam plate aperture, the other slide is correspondingly guided at the same time as a function of this rim.

Preferably the cross-section of the movable cam plate recess shall be at least approximately an ellipse. The cross-section may be configured in relation to need in a manner that it shape is arbitrary. Preferably regarding the guidance of the two slides however, the shape will be elliptical or any continuous geometry devoid of offsets or jumps.

The technical disclosure of the present document moreover includes an assembly bench comprising a supporting lower framework and assembling equipment of the present invention. The assembling equipment is easily and efficiently operable as an assembly bench.

The technical disclosure of the present invention furthermore includes an assembling method to assemble a profiled structure to a pane, in particular to a motor vehicle's windshield, comprising the following steps: feeding a pane by means of a pane guiding device to a first and predetermined assembly position, feeding a profiled structure to a second assembly position which is near the first assembly position, joining the pane and the profiled structure at a joint assembly position, where the step of joining includes the step of activating elastic compressive means in order to change latter's volume.

The change in volume illustratively may be volume expansion and/or a change in shape or a deformation of the volume.

The method of the present invention allows rapid, reliable and simple connection between a profiled structure and a pane. On account of the expansion of the compressive means, slight tolerances, gaps, play and the like are easily compensated while nevertheless good compression and hence good connection between profiled structure and pane are assured.

In one assembling method, preferably the activation step shall include also the step of feeding a pressurizing medium to and/or into the compressive means. In this way the method can be carried out in simple and ecological manner.

A preferred illustrative embodiment mode calls for the feed step to include also the step feeding a pressurizing medium to a first compressive means and a second pressurizing medium to a second compressive means, where said steps may be simultaneous or offset in time. Illustratively first a compressive means operating in one direction may be pressurized to compensate tolerances in this direction by the compressive means' volumetric expansion. Following this alignment, another alignment may be carried out in an operational direction of the second compressive means, the first compressive means optionally remaining in a pressurized state or being de-aerated.

The present invention also prefers that the following steps be included when feeding a pane: displacing the pane feed device into an initial position, opening the pane feed device, inserting the pane, aligning the pane, affixing the pane, displacing the pane feed device into the first a assembly position,

In this manner a pane may be moved into a first assembly position in a few steps. Importantly, the method may be optimally automated.

In similar manner the present invention prefers that further steps be included in the profiled structure feed stage: the procedure of profiled structure feed into an initial position, opening the profiled structure's feed device, inserting the profiled structure, aligning the profiled structure, affixing the profiled structure, moving the profiled structure's feed device into the second assembly position. Again a simple method is hereby made available, allowing moving a profiled structure into a second assembly position in a few steps. The latter steps as well as the former steps feeding the pane may be carried out manually, in automated manner or also in partly automated manner.

The technical disclosure of the present invention furthermore provides a computer program comprising program coding means to carry out all steps of the present invention when the program is implemented on a computer.

Said technical disclosure also provides program coding means stored on a computer-readable data medium to implement the method of the present invention when the program product is implemented on a computer.

The computer program allows efficiently computerizing the method and thereby enables automating well the method as a whole. In order to implement the said method at as many stations as possible the said computer program also may be stored on or in the form of computer program products. In this manner the computer program may be available at large and the method may be used widely.

The technical disclosure of the present invention also includes using its assembling equipment at its assembly bench to assemble panes, windshields, window panes, plastic panes, glass panes and the like in conjunction with profiled structures as defined herein, profiled structure frames, rubber profiled structures, and the like in automotive engineering, in the technology of windows, doors and fittings and the like. Accordingly the method of the present invention is applicable to wide fields of assembly technology.

The assembling sequence is described below:

The assembling equipment is in its initial state. When in this initial state, the pane feed device together with its parts also is in its own initial state. In other words, the overall pane carriage part of the pane feed device and receiving and moving the pane is in its rearmost, stopped position. The clamps constituted at the pane carriage and used to clamp the pane onto the pane carriage are preferably pneumatic and are active. The roller stops also constituted at the pane carriage to allow pane alignment are extended into their lower position and therefore are ready to operate as stops. The centering clamping jaws to grip and clamp the pane in centering manner are extended. The pane compressive rollers to compress the pane also are extended. In this state, the pane is easily inserted into the pane feed device.

The profiled structure's feed device is in the following initial state:

All the clamps to clamp the profiled structure are open. The tube compressive means are de-aerated and hence de-activated. The two slides, namely the vertical and the horizontal slide, constituted at the profiled structure's feed device are situated in a lower respectively rear position. The thrust cylinder displacing the two slides is correspondingly in its retracted position. The pneumatically operated clamps present at the vertical slide are open.

The assembling method, i.e. The joining procedure, runs as follows:

A pane is coarsely inserted by one pane edge that shall receive the compressed profiled structure in the direction of the roller stops and, in the event the pane is curved, said curvature is convex upward. This operation may be carried out manually or robotically. Next the compression roller moves forward in order to displace the pane, and in particular its edge that shall receive the profiled structure, toward the roller stop(s) of which there are preferably 2. Then the centering clamp jaws are closed and the pane is kept on the carriage in its clamped state. To assure reliable support, use is made of support balls, of a pane receiving track, the said roller stops, the compressive roller and the centering clamp jaws in order to position the pane with high accuracy. Next the roller stops are lifted and the pneumatic clamping of the pane carriage is lifted then the compression roller is retracted. Next the pane is moved until stopped into the first assembly position. When in this first assembly position, the pneumatic clamping of the pane carriage is activated and the pane is firmly held on the carriage.

In parallel with the steps carried out beforehand or subsequently, the profiled structure joined with the pane will be inserted into the receiving track. The receiving track is three-dimensional (3D). The clamping elements close. The profiled structure preferably is fitted with an adhesive tape comprising a protective cover (liner) at least in part in the portion to be joined. Preferably this adhesive tape runs the full length of the profiled structure. To join the pane and the profiled structure, first the liner shall be removed. Then the thrust cylinder is advanced and thereby the front or vertical slide is displaced vertically and guided by a movable cam plate and the horizontal slide with the integrated 3D receiving track moves in the direction of the lower pane edge. At this time the profiled structure's feed device has been moved into a second assembly position.

In these two positions, the pane and the profiled structure adhesive tape have been moved vertically into a defined distance between them. This distance preferably is in the range between 0 and 20 mm, preferably between 0.1 and 10 mm, most preferred between 0.2 and 1 mm and preferably it shall be about 0.5 mm. The pane and the profiled structure do not touch each other.

A rubber sealing lip of the profiled structure horizontally makes contact with the pane edge in gap-less or nearly gap-less manner.

Next the large clamping elements constituted at the pane feed device are closed in order to compress the pane against the pane supporting track. The first tube, which acts essentially in the horizontal direction, is pressurized to compensate tolerances, gaps and the like between the rubber lip and the lower pane edge. The profiled structure's small clamping elements are opened and the second tube is pressurized to initiate contact between the profiled structure's adhesive tape and the lower pane surface and to bond them to each other.

Following this bonding procedure, the tubes are de-aerated and the vertical carriage clamping is lifted. The thrust cylinder is retracted and moves the horizontal slide downward. The horizontal slide is controlled by the movable cam plate and moves down with the vertical slide by a distance preferably about 10 mm to remove the bonded profiled structure out of the receiving track. Thereupon the movable cam plate constrains the horizontal slide to move along the reset curve into its initial position. Together with the pane and the bonded profiled structure, the pane carriage is moved back into the rear stop position, pane carriage clamping is deactivated, the centering jaws are opened and the pane together with the bonded profiled structure may be removed. Thereupon the roller stops are moved down into the stop position and as a result the initial state has been restored.

Further features, details and advantages of the present invention are defined in the claims and discussed below by means of illustrative embodiments in relation to the appended drawings.

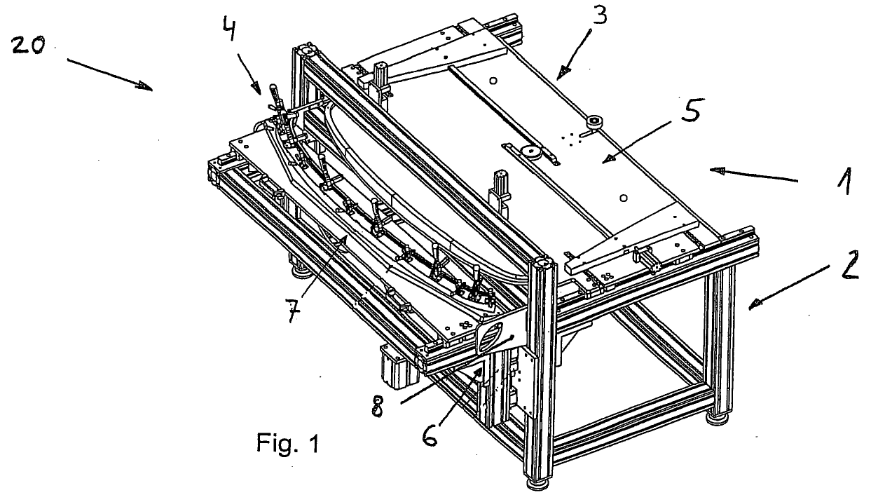

FIG. 1 is a schematic perspective of assembling equipment of the invention together with a supporting lower framework,

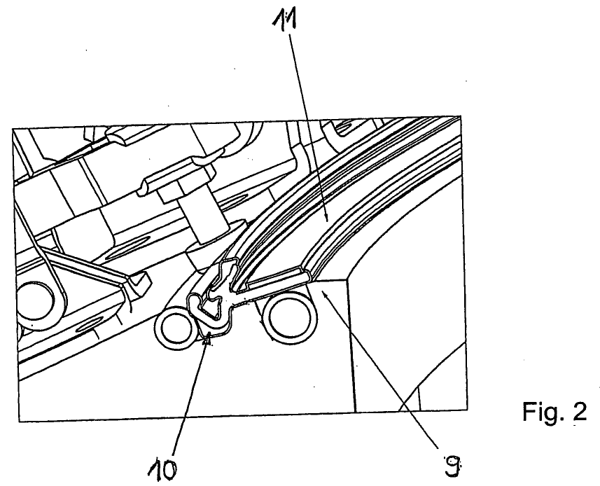

FIG. 2 is a schematic detailed view of a profiled structure seat configured at the profiled structure's feed device,

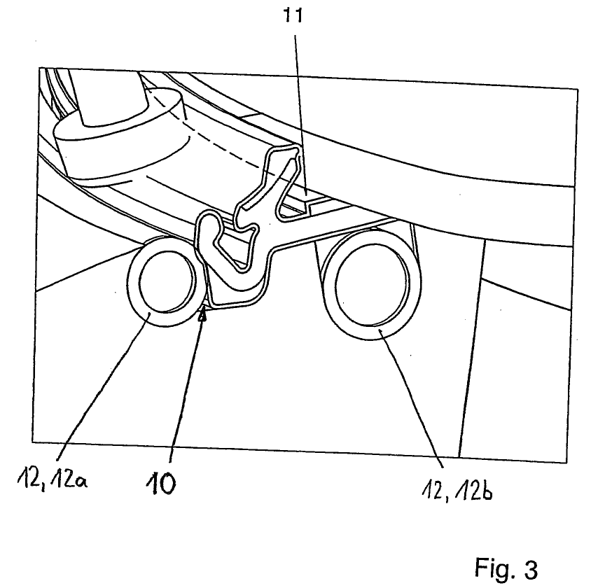

FIG. 3 is a schematic perspective view of a receiving track together with a profiled structure and joining means designed as compressive means, and

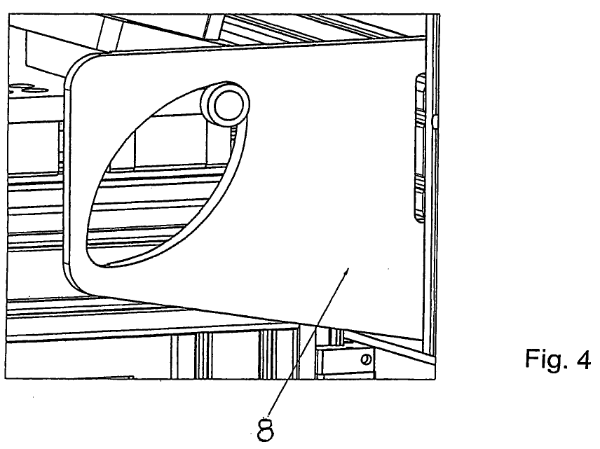

FIG. 4 is a schematic perspective detailed view of a movable cam plate.

FIG. 1 is a schematic, perspective view of assembling equipment 1 comprising a lower support framework 2. The lower framework 2 and the assembling equipment 1 together constitute an assembly bench 20. The pane feed device 3 comprises a displaceable pane carriage 5 fitted with appropriate parts to receive and clamp a pane. The pane carriage is displaceable substantially in a horizontal plane. When the pane is displaced horizontally, it is moved as far as a stop and it is then appropriately aligned.

The profiled structure's feed device 4 comprises a vertical slide 6 for substantially vertical displacements. The horizontal slide 7 and the vertical slide 6 are linked to each other by a movable cam plate 8 whereby the horizontal slide 7, during the vertical displacement of the vertical slide 6, in addition to its horizontal motion also carries out a vertical motion according to the shape of the movable cam plate 8.

A pane and a profiled structure are moved by the feed devices 3, 4 to be assembled to each other. The pane is moved into a first assembly position and the profiled structure into a second assembly position, said first and second assembly positions being adjacent to each other, as a result of which the pane and the profiled structure are positioned to be close to one another though not yet being assembled. In other words, at least one gap remains in at least one direction between said pane and profiled structure.

FIG. 2 shows a schematic, perspective of a profiled structure seat 9. The profiled structure seat 9 is constituted at the profiled structure's feed device. The profiled structure seat 9 comprises a corresponding recess in the form of a receiving track 10 to receive therein a profiled structure 11 to be assembled. The geometry of the receiving track 10 may be arbitrary and may be fairly complex in 3D. Clamping and/or retaining means are mounted on the profiled structure seat 9 to affix the profiled structure 11 and keep said profiled structure in the receiving track 10. In this Figure the profiled structure 20 is configured in the receiving track 10. FIG. 3 shows a larger scale of the receiving track 10 and the profiled structure 11.

FIG. 3 is a schematic and perspective view of the receiving track 10 with a profiled structure 11 configured in it.

The receiving track 10 matches the profiled structure 11 to be seated in it, as a result of which said profiled structure shall be retained in predetermined and reliable manner within the space of the receiving track 10. The profiled structure 11 is made of plastic and is fitted with a compression surface to press the profiled structure against the pane. An adhesive tape with a cover strip is configured on said compression surface. Before joining, the cover strip is appropriately removed and consequently the adhesive tape together with the corresponding bonding agent can be forced against the pane. The receiving track 10 is designed as a recess in a profiled structure. Besides the recess constituting the receiving track 10, said profiled structure contains further recesses to receive joining elements. Said joining elements herein are designed as compressive means 12, a first compressive means being designed as a first tube 12a and a second compressive means being designed as a second tube 12b. The first tube 12a is more or less configured within a recess laterally against the receiving track 10 for the purpose of applying a substantially lateral compression against the profiled structure 11. The recesses constituting the receiving track 10 and the first compressive means are continuous in this embodiment, that is they constitute a common recess. The second tube 12b is configured in a recess configured approximately underneath the receiving track 10 and is designed to apply a substantially vertical compression on the profiled structure 11. The clearances to constitute the receiving track 10 and the second compressive means are continuous herein, that is, they a common recess. As regards the profiled structure 11 configured in the receiving track, said profiled structure and the compressive means 12 are linked operationally, that is, when the compressive means 12 are activated, said compressive means will act on the profiled structure 11. The tubes 12a, 12b are made of an elastic, expansible material. When these tubes 12a, 12b are loaded with a pressurizing medium, for instance compressed air, the tubes 12, 12b expand radially and thereby enlarge their volume, this volume also including the inside of the tubes. Such expansion transmits a force from the tubes 12a, 12b to the profiled structure 11. This force (compression) forces the profiled structure 11 against an associated pane, and a gap between said pane and the profiled structure 11 is compensated in relation to the control exerted on said compressive means 12.

When the tubes 12a, 12b are not driven simultaneously, the profiled structure 11 is acted on at first in one direction, for instance horizontally, by the first tube 12a, and then in a second direction, for instance vertically, by the second tube 12b. In this manner there may be at first for instance horizontal gap compensation before there shall be a substantially vertical compression of the profiled structure 11 against the pane.

After the profiled structure 11 has been pressed against the pane, the slides are moved apart. In this process the profiled structure's feed device is lowered and the pane's feed device is retracted. The profiled structure's feed device comprises two displaceable slides, a horizontal slide and a vertical slide. These slides are linked to each other, a movable cam plate determining at least partly the displacements of vertical and horizontal slides. The movable cam plate is shown in FIG. 4.

FIG. 4 is a schematic, perspective detailed view of a movable cam plate 8. The movable cam plate 8 is constituted as an approximately elliptical aperture in a body. The contour of said aperture defines within a range a so-called reset curve or a path for profiled structure “ejection” or removal. Part of the horizontal slide enters the aperture, whereby this horizontal slide is guided along the aperture's contour. If now the vertical slide is reset, the horizontal slide linked to the horizontal one initially also moves vertically. By guiding the horizontal slide in the movable cam plate 8, said vertical motion however shall be deflected along a path predetermined by the contour of the aperture in the movable cam plate 8. In the present instance, when the vertical slide is lowered, the horizontal slide controlled by the movable cam plate 8 initially shall be moved downward by about 10 mm in the absence of a horizontal displacement. In this process the profiled structure bonded to the pane is “ejected” (or removed) from the receiving track. Because of the aperture contour of the movable cam plate 8, and after the said vertical displacement has taken place, the horizontal slide is moved along the reset curve. As a result the horizontal slide returns into its initial state.

The present invention is not restricted to the above described embodiment modes but instead allows many variations.

All features and advantages including design details, spatial configurations and method steps implicit as well as explicit in the claims, specification and drawings may be construed inventive per se as well as in arbitrary combinations.

### LIST OF REFERENCES

1 Assembling equipment
2 Lower framework
3 Pane feed device
4 Profile structure's feed device
5 Pane carriage
6 Vertical slide
7 Horizontal slide
8 Cam plate
9 Profiled structure seat
10 Receiving track
11 Profiled structure
12 Compressive means
12a First tube
12b Second tube
20 Assembly bench

1. Assembling equipment (1) to assemble a profiled structure (11) to a window pane, in particular to a motor vehicle windshield, comprising:
a pane feed device (3) to guide a pane into a first predetermined assembly position,
a profiled structure's feed device (4) to guide a profiled structure (11) into a second assembly position near the first assembly position,
joining means to join the profiled structure (11) and the pane at a common assembled position,
where the joining means comprise elastic, expansible compressive means (12) which when activated do change in volume in a manner that the pane and the profiled structure (11) shall be assembled.

2. Assembling equipment (1) as claimed in claim 1, characterized in that the compressive means (12) include a first tube (12a) made of an elastic material.

3. Assembling equipment (1) as claimed in claim 1, characterized in that the compressive means (12) include a second tube (12b) made of an elastic material.

4. Assembling equipment (1) as claimed in claim 1, characterized in that the profiled structure's feed device (4) comprises a profiled structure seat (9) receiving the profiled structure (11).

5. Assembling equipment (1) as claimed in claim 1, characterized in that the profiled structure's feed device (4) moreover comprises a displaceable, profiled structure receiving slide which is fitted with a profile structure seat (9).

6. Assembling equipment (1) as claimed in claim 1, characterized in that the profiled structure seat (9) comprises a receiving track (10) receiving the profiled structure (11).

7. Assembling equipment (1) as claimed in claim 1, characterized in that the compressive means (12) are operationally connected to and on the receiving track (9).

8. Assembling equipment (1) as claimed in claim 1, characterized in that the compressive means (12) are configured near and along the contour of the receiving track (9).

9. Assembling equipment (1) as claimed in claim 1, characterized in that the first compressive means is operationally with and laterally configured at the receiving track (9) in order to transmit a substantially sideways compression to an inserted profiled structure (11).

10. Assembling equipment (1) as claimed in claim 1, characterized in that the second compressive means is operationally linked to the receiving track (9) and configured underneath it in order to transmit a compression substantially perpendicularly to a connection zone to an inserted profiled structure (11).

11. Assembling equipment (1) as claimed in claim 1, characterized in that the compressive means (12) are designed as compressed air tubes which can be activated by compressed air.

12. Assembling equipment (1) as claimed in claim 1, characterized in that the profiled structure's feed device comprises a vertically displaceable vertical slide (6) and a horizontally displaceable horizontal slide (7).

13. Assembling equipment (1) as claimed in claim 1, characterized in that the vertically displaceable vertical slide (6) and the horizontally displaceable horizontal slide (7) are guided in linked manner by a movable cam plate (8).

14. Assembling equipment (1) as claimed in claim 1, characterized in that the movable cam plate (8) is fitted with an aperture guiding one the two linked slides.

15. Assembling equipment (1) as claimed in claim 1, characterized in that the movable cam plate (8) is rigidly joined to the other slide of the two slides.

16. Assembling equipment (1) as claimed in claim 1, characterized in that the aperture cross-section is at least approximately an ellipse.

17. An assembly bench (20) comprising a supporting lower framework (2) and assembling equipment (1) as claimed in claim 1.

18. An assembling method to affix a profiled structure (11) to a pane, in particular to a motor vehicle windshield, comprising the steps:
guiding a pane by means of a pane feed device (3) into a first, predetermined assembly position,
guiding a profiled structure (11) by means of a profiled structure's feed device (4) into a second assembly position near the first one,
joining the pane and the profiled structure (11) into a common assembled position, the step of joining including the step of activating elastic compressive means (12) in order to change the volume of said means.

19. Assembling method as claimed in claim 18, wherein the activation step includes
feeding a pressurizing medium to and/or into the compressive means (12).

20. Assembling method as claimed in claim 18, wherein the feed step also includes the step:
feeding a pressurizing medium to a first compressive means, and
feeding a pressurizing medium to a second compressive means, the steps being optionally carried out simultaneously or staggered in time.

21. Assembling method as claimed in claim 18, characterized in that
feeding a pane includes the further steps:
moving the pane feed device (3) into an initial position.
opening the pane's feed device (3),
inserting the pane,
aligning the pane,
affixing the pane,
moving the pane feed device (3) into the first assembly position.

22. Assembling method as claimed in claim 18, characterized in that
feeding the profiled structure (11) includes the further steps:
moving the profiled structure's feed device (4) into an initial position,
opening the profiled structure's feed device (4),
inserting the profiled structure (11),
aligning the profiled structure (11),
affixing the profiled structure (11),
moving the profiled structure's feed device (4) into the second assembly position.

23. A computer program comprising program code means to implement all steps of each arbitrary claim 1 when the program is carried out on a computer.

24. A computer program product with program code means stored on a computer readable data medium to carry out the method according to any arbitrary claim 1 when the program product is implemented on a computer.

25. In a method of using assembling equipment to assemble panes, motor vehicle windshields, window panes, plastic panes, glass panes and the like with profiled structures (11), contoured frames, contoured rubber and the like in particular in automotive engineering, in the technology of windows, doors and fittings and the likes the improvement comprising using the assembling equipment (1) of claim 1, and wherein the assembling equipment is part of an assembly bench (20) comprising a supporting lower framework (2).
